(19) United States
(12) Patent Application Publication
(10) Pub. No.: US 2013/0346321 A1
(43) Pub. Date: Dec. 26, 2013

(54) COMMODITY SALES DATA PROCESSING APPARATUS AND METHOD FOR ISSUING WARRANTY CIRTIFICATE BY THE SAME

(71) Applicant: TOSHIBA TEC KABUSHIKI KAISHA, TOKYO (JP)

(72) Inventor: Yoshihiro Karita, Shizuoka-ken (JP)

(21) Appl. No.: 13/922,425

(22) Filed: Jun. 20, 2013

(30) Foreign Application Priority Data
Jun. 21, 2012 (JP) 2012-139297

(51) Int. Cl. G06Q 30/00

(52) U.S. Cl. CPC G06Q 30/012
USPC 705/302

(57) ABSTRACT

A commodity sales data processing apparatus includes a warranty certificate issue determination section configured to determine whether it is set that issue of the warranty certificate is executable or it is set that issue of the warranty certificate is not executable on the commodity specified by the commodity code, a first warranty certificate issue section configured to read the warranty certificate data corresponding to the commodity code to issue a warranty certificate if it is determined that it is set that issue of the warranty certificate is executable, and a second warranty certificate issue section configured to read the warranty certificate data including data for specifying the commodity based on the commodity code specified if it is determined that it is set that issue of the warranty certificate is not executable and issue of the warranty certificate is instructed.

### CROSS-REFERENCE TO RELATED APPLICATION

This application is based upon and claims the benefit of priority from Japanese Patent Application No. 2012-139297, filed Jun. 21, 2012, the entire contents of which are incorporated herein by reference.

### FIELD

Embodiments described herein relate to a commodity sales data processing apparatus and a method for issuing a warranty certificate by the apparatus.

### BACKGROUND

In recent years, in a commodity sales data processing apparatus such as a POS terminal etc, a warranty certificate made by printing the warranty items of a purchased commodity on for example a receipt paper can be issued from the apparatus upon operation of a warranty certificate issue key. Furthermore, by setting an issue flag of the warranty certificate into a commodity master file, it can be selected whether or not the warranty certificate of the commodity is issued, and the warranty items are printed to automatically issue the warranty certificate of a commodity when the commodity is purchased.

Since a shop clerk is not required to make the warranty certificate in handwriting, the workload of the shop clerk for issuing a warranty certificate can be reduced.

### BRIEF DESCRIPTION OF THE DRAWINGS

FIG. 1 is a perspective view of a POS terminal according to one embodiment;

FIG. 2 is a block diagram illustrating the POS terminal;

FIG. 3 is a diagram showing a commodity master file;

FIG. 4 is a functional block diagram of the POS terminal;

FIG. 5 is a flowchart showing the processing procedure; and

FIG. 6 is a diagram showing an output sample of a warranty certificate.

### DETAILED DESCRIPTION

In accordance with an embodiment, a commodity sales data processing apparatus includes an input section configured to input a commodity code for specifying a commodity, a warranty certificate data storage section configured to store a warranty certificate data including data, required to warrant the commodity, which is associated with the commodity code, a warranty certificate issue instruction section configured to instruct issue of the warranty certificate with the commodity code specified, a warranty certificate issue determination section configured to determine with reference to the warranty certificate data storage section whether it is set that issue of the warranty certificate is executable or it is set that issue of the warranty certificate is not executable on the commodity specified by the commodity code input through the input section, a first warranty certificate issue section configured to read out the warranty certificate data corresponding to the commodity code from the warranty certificate data storage section to output them to a printer to issue a warranty certificate if the warranty certificate issue determination section determines that it is set that issue of the warranty certificate is executable, and a second warranty certificate issue section configured to read out the warranty certificate data including data for specifying the commodity from the warranty certificate data storage section based on the commodity code specified to output them to the printer to issue the warranty certificate if the warranty certificate issue determination section determines that it is set that issue of the warranty certificate is not executable and the warranty certificate issue instruction section instructs issue of the warranty certificate.

In accordance with an embodiment, a method for issuing a warranty certificate by a commodity sales data processing apparatus equipped with a warranty certificate data storage section storing a warranty certificate data, including data, required to warrant a commodity, that is associated with a commodity code, the method includes inputting the commodity code for specifying the commodity, instructing issue of the warranty certificate of the commodity specified by the commodity code, determining with reference to the warranty certificate data storage section whether it is set that issue of the warranty certificate is executable or it is set that issue of the warranty certificate is not executable on the commodity specified by the commodity code, issuing the warranty certificate by reading the warranty certificate data corresponding to the commodity code from the warranty certificate data storage section and by outputting them to a printer if it is determined that it is set that issue of the warranty certificate is executable, and issuing the warranty certificate by reading the warranty certificate data including data for specifying the commodity from the warranty certificate data storage section based on the commodity code and by outputting them to the printer if it is determined that it is set that issue of the warranty certificate is not executable, and issue of the warranty certificate is instructed.

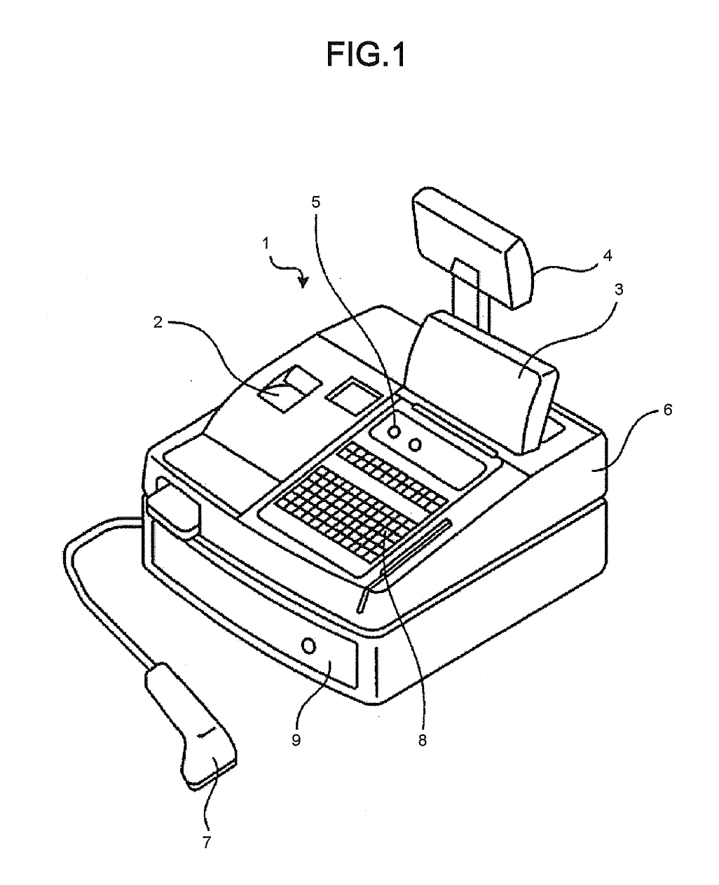

A present embodiment will be described referring to FIGS. 1 to 6. FIG. 1 is a perspective view showing the embodiment, and the POS terminal 1 is illustrated as one example of a commodity sales data processing apparatus.

In FIG. 1, the POS terminal 1 includes a POS terminal main body 6 and a drawer unit with a drawer 9 disposed at its lower part. The POS terminal 1 is equipped with a receipt printer unit 2 that stores a lengthy receipt paper and prints sales information on the receipt paper to issue the receipt from the receipt issue port, a display for shop clerk 3 that displays data to a shop clerk, a display for customer 4 that displays data to a customer, a keyhole 5 into which a start key that activates the POS terminal 1 is inserted, a touch type barcode reader 7 connected to the POS terminal 1 via an I/O device, and a keyboard 8 on which a numerical keypad, a department key, a subtotal key, a deposit/cash total key, a receipt issue key, and a clear key etc are arranged.

The display for shop clerk 3 is arranged such that it is directed to the shop clerk side, and the display for customer 4 is directed to the customer side. Such displays are similar to one the other and, for example, are formed with a liquid crystal display, a fluorescent tube or a seven-segment display.

The drawer unit houses the drawer 9, which stores monies from a customer and changes to a customer.

In order to specify the commodity, the barcode reader 7 reads out a barcode as a code symbol including a commodity code attached on the commodity.

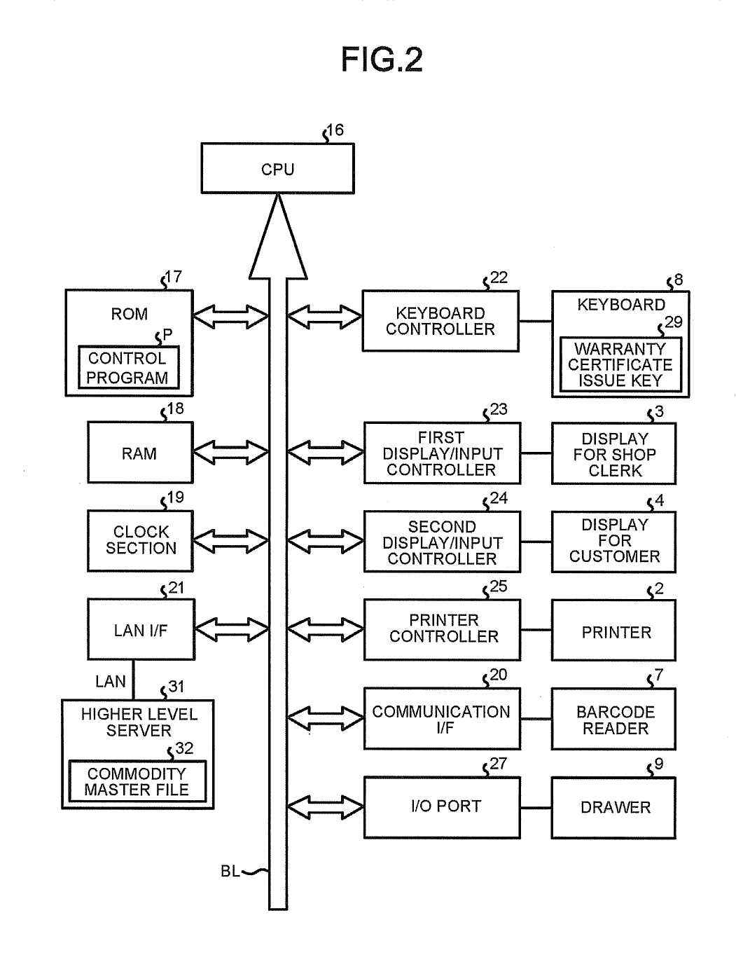

FIG. 2 is a block diagram showing the hardware arrangement of the POS terminal 1. As shown in FIG. 2, a ROM (Read Only Memory) 17, a RAM (Random Access Memory) 18, a clock section 19 are connected to a CPU (Central Processing Unit) 16 via a data bus line BL. The CPU 16, the ROM 17 and the RAM 18 constitute a control section 61.

The barcode reader 7 via a communication I/F 20, the keyboard 8 via a keyboard controller 22, the display for shop clerk 3 via a first display/input controller 23, the display for customer 4 via a second display/input controller 24, the printer 2 via a printer controller 25, and the drawer 9 via I/O port 27 are electrically connected to the data bus line BL. A warranty certificate issue key 29 that is manually operated to issue a warranty certificate is arranged on the keyboard 8.

A LAN I/F 21 for connecting a higher-level server 31 is arranged in the data bus line BL. The higher-level server 31 is connected to the LAN I/F 21 via the LAN line.

The higher-level server 31 collects sales data from the POS terminal 1, and meanwhile sends the sales data to a headquarters computer (not shown). Also, the higher-level server 31 includes a commodity master file 32 and thus the server 31 receives the commodity data such as a commodity name, a commodity price, etc. from the headquarters computer, and stores the received commodity data into the commodity master file 32.

Various control programs P for controlling the POS terminal 1 are stored in the ROM 17.

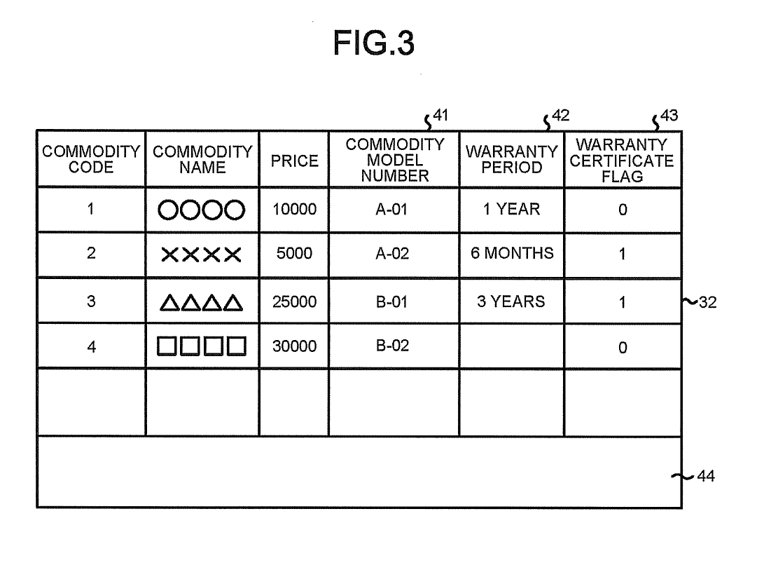

As shown in FIG. 3, the commodity master file 32 includes a commodity model number area 41 in which not only a commodity name and price but also a commodity model number namely a warranty certificate data for specifying the commodity, corresponding to a commodity code are stored, and a warranty period area 42 in which a warranty period is stored. The commodity master file 32 also includes a warranty certificate flag area 43 in which a flag indicating whether or not issue of the warranty certificate is executable corresponding to the commodity code is stored. In the present embodiment, a flag “1 (one)” is set in the warranty certificate flag area 43 in a case that issue of the warranty certificate is executable, and a flag “0 (zero)” in a case that issue of the warranty certificate is not executable.

The higher-level server 31 includes a sales data area 44 in which sales information sent from the POS terminal 1 is stored to send the sales information in response to the request from the headquarters computer.

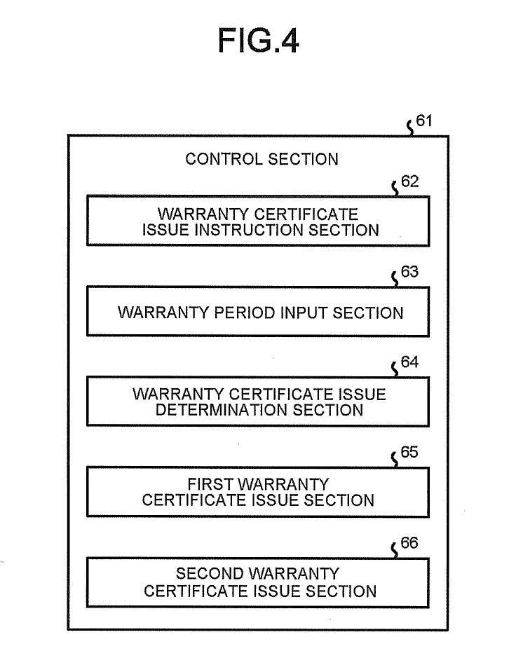

Various processing executed by the POS terminal 1 according to various control programs P will be illustrated. A control section 61 shown in FIG. 4 realizes a warranty certificate issue instruction section 62, a warranty period input section 63, a warranty certificate issue determination section 64, a first warranty certificate issue section 65 and a second warranty certificate issue section 66 according to the control programs P.

The warranty certificate issue instruction section 62 has a function of instructing issue of the warranty certificate by specifying a commodity code, and the warranty period input section 63 has a function of inputting a warranty period in the warranty certificate. The warranty certificate issue determination section 64 has a function of determining whether or not it is set that issue of the warranty certificate is executable for a commodity specified according to the commodity code input by the input section with reference to the warranty certificate data storage section. The first warranty certificate issue section 65 has functions of reading the warranty certificate data corresponding to the commodity code from the warranty certificate data storage section to output it to the printer if the warranty certificate issue determination section 64 determines that it is set that issue of the warranty certificate is executable and of issuing the warranty certificate. The second warranty certificate issue section 66 has functions of reading the warranty certificate data including the data for specifying the commodity according to the commodity code specified from the warranty certificate data storage section to output it to the printer if the warranty certificate issue determination section 64 determines that it is set that issue of the warranty certificate is not executable and issue of the warranty certificate is instructed by the warranty certificate issue instruction section 62 and of issuing the warranty certificate.

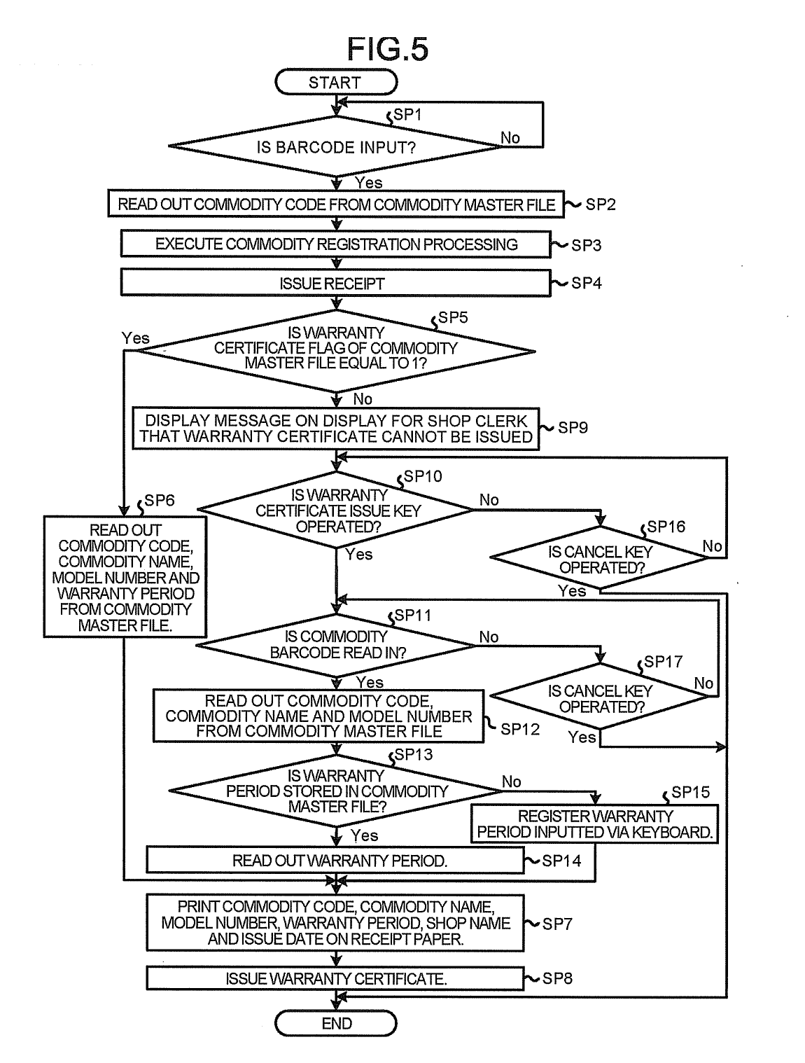

FIG. 5 is a flowchart of the processing executed when the barcode symbol attached to the commodity is read out by the barcode reader 7. In FIG. 5, the control section 61 executes the following processing. The control section 61 stands by until the barcode symbol is read out (No in SP1), if the barcode symbol is read out (Yes in SP1), the commodity code included in the barcode symbol is analyzed, and commodity information corresponding to the commodity code is read from the commodity master file 32 (SP2) to execute the commodity registration (SP3). The commodity registration according to the present embodiment is to store commodity information (commodity name and commodity price) in a buffer based on the commodity code read out. Then, the receipt on which the commodity code, the commodity name, the price, etc. are printed by the printer 2 is issued (SP4).

Next, the warranty certificate of the commodity is issued. The control section 61 enables the warranty certificate issue determination section 64 to determine whether or not the flag “1” is stored in the warranty certificate flag area 43 corresponding to the commodity code in the commodity master file 32 (SP5). If the flag “1” is stored (Yes in SP5), it is executable to automatically issue the warranty certificate. The control section 61 enables the first warranty certificate issue section 65 to read out the commodity model number from the commodity model number area 41, and the warranty period from the warranty period area 42 (SP6), as well. Then, the commodity model number, warranty period along with the date of today, commodity code, commodity name, etc. are printed on the receipt paper (SP7) to issue the warranty certificate (SP8).

On the other hand, if the flag “0” is stored in the warranty certificate flag area 43 corresponding to the commodity code in the commodity master file 32 (No in SP5), it is not executable to automatically issue the warranty certificate. The control section 61 indicates on the display for shop clerk 3 a massage that the warranty certificate can not be automatically issued (SP9). Then, the shop clerk tries to manually issue the warranty certificate. Firstly, the shop clerk operates the warranty certificate issue key 29 and reads out the barcode attached to the commodity by the barcode reader 7. Then the control section 61 determines whether or not the warranty certificate issue key 29 is operated (SP10). If the key 29 is operated (Yes in SP10), then the control section 61 determines whether or not the barcode on the commodity is read out (SP11). If the barcode is read out (Yes in SP11), the control section 61 reads out the commodity code, and also reads out the commodity name and the model number corresponding to the commodity code (SP12).

Next, the control section 61 determines whether or not the warranty period is stored in the warranty period area 42 in the commodity master file 32 (SP13). In this determination, the control section 61 determines whether the data of the concrete warranty period is stored. If the warranty period is stored (commodities of commodity code 1, commodity code 2, and commodity code 3 shown in FIG. 3) (Yes in SP13), then the control section 61 reads out the warranty period (SP14). The control section 61 prints the warranty period along with the commodity code, commodity name and model number that are read out beforehand on the receipt paper (SP7) to issue the warranty certificate (SP8).

If the warranty period is not stored in the warranty period area 42 in the commodity master file 32 (commodity of commodity code 4 shown in FIG. 3) (No in SP13), the control section 61 indicates on the display for shop clerk 3 a message “Input a warranty period”. The shop clerk sees this message and inputs the warranty period data through the keyboard 8. Then, the control section 61 enables the warranty period input section 63 to register the inputted warranty period (SP15). After the registration of the warranty period is finished, the control section 61 enables the second warranty certificate issue section 66 to print the warranty period along with the commodity code, commodity name, and commodity model number for specifying the commodity that are read out earlier on the receipt paper (SP7) and to issue the warranty certificate (SP8).

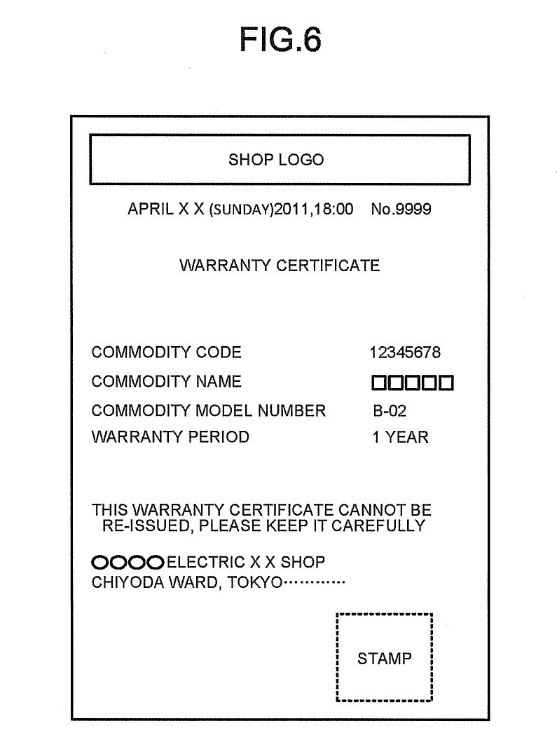

An example of the warranty certificate issued according to the present embodiment is described referring to FIG. 6. If the flag in the warranty certificate flag area 43 is “1”, the control section 61 issues a warranty certificate as shown in FIG. 6 following the issuance of the receipt. A shop logo, an issue date timed by the clock section 19, a title “warranty certificate”, the commodity code of the warranted commodity, the commodity name, the commodity model number, the warranty period, and furthermore information of the shop that issues the warranty certificate are printed on the warranty certificate.

If the flag in the warranty certificate flag area 43 is “0”, the control section 61 issues the warranty certificate shown in FIG. 6 as similar to the above by manually inputting the warranty period through the keyboard 8 even if the warranty period is not stored, provided that the warranty certificate issue key 29 is operated and then the barcode on the commodity to which the warranty certificate is issued is read out.

According to the above embodiment, the warranty certificate of a commodity can be easily issued as long as the shop clerk operates the warranty certificate issue key 29 to read the barcode on the subject commodity through the barcode reader 7, even if the warranty certificate can not automatically issued because the warranty certificate flag is “0”. Thus, it is not required that the shop clerk inputs the commodity name, the commodity model number, etc. in handwriting to make the warranty certificate.

The commodity name and the commodity model number are read out from the commodity master file 32, and therefore it is unnecessary to separately arrange a memory for storing the warranty certificate data.

In a case that the warranty period is stored in the warranty certificate period area 42 of the commodity master file 32, the warranty certificate can be made by using the data, and thus the burden of the shop clerk can be reduced.

The warranty certificate on which a warranty period is printed can be issued by inputting the warranty period through the keyboard by the shop clerk even if the warranty period is not stored in the warranty period area 42 of the commodity master file 32, and thus it is also unnecessary that the shop clerk writes the warranty period on the warranty certificate in handwriting.

The present embodiment is presented as an example, and it is not intended to limit the scope of the invention. The novel embodiment can be implemented in other various forms, and various omissions, replacements and modifications can be carried out without departing from the gist of the invention. The embodiment and its modification are included in the scope or gist of the invention, and also included in the invention stated in the claims and its equivalent.

For example, in the present embodiment, the commodity master file 32 is arranged in the higher-level server 31, and commodity information is read out from the commodity master file 32 . However, the commodity master file 32 may be arranged in the POS terminal 1.

In the present embodiment, the commodity code, the commodity name, and the commodity model number, i.e., data for specifying the commodity, that are printed on the warranty certificate are stored in the commodity master file 32, and they are read out from the commodity master file 32. However, it may also be possible that they are stored in other storage unit and are read out therefrom.

In the present embodiment, one warranty certificate is issued for one commodity purchased. In a case in which a plural warranty certificates are required for a plural commodities purchased, however, it is possible to issue a warranty certificate one by one for each commodity as in the present embodiment. However, it is also possible to collectively print the warranty certificate information of the plural commodities on one warranty certificate to issue as a single warranty certificate.

In the present embodiment also, the shop clerk firstly operates the warranty certificate issue key 29 and then the barcode of the commodity is read through the barcode reader in case that the warranty certificate is manually issued. However, it is also possible that the barcode of the commodity the warranty certificate of which is issued is read first and then the warranty certificate issue key 29 is operated.

In the present embodiment, the shop clerk inputs the warranty period through the keyboard 8 if the warranty period is not stored in the warranty period area 42. However, it is also possible that a warranty period table which stores, in advance, the warranty period of each commodity corresponding to the commodity code is prepared, and then the warranty period for a subject commodity is selected from the table to input it.

What is claimed is:

1. A commodity sales data processing apparatus, comprising:
an input section configured to input a commodity code for specifying a commodity;
a warranty certificate data storage section configured to store a warranty certificate data including data, required to warrant the commodity, which is associated with the commodity code;
a warranty certificate issue instruction section configured to instruct issue of the warranty certificate with the commodity code specified;
a warranty certificate issue determination section configured to determine with reference to the warranty certificate data storage section whether it is set that issue of the warranty certificate is executable or it is set that issue of the warranty certificate is not executable on the commodity specified by the commodity code input through the input section;
a first warranty certificate issue section configured to read out the warranty certificate data corresponding to the commodity code from the warranty certificate data storage section to output them to a printer to issue a warranty certificate if the warranty certificate issue determination section determines that it is set that issue of the warranty certificate is executable; and
a second warranty certificate issue section configured to read out the warranty certificate data including data for specifying the commodity from the warranty certificate data storage section based on the commodity code specified to output them to the printer to issue the warranty certificate if the warranty certificate issue determination section determines that it is set that issue of the warranty certificate is not executable and the warranty certificate issue instruction section instructs issue of the warranty certificate.

2. The commodity sales data processing apparatus according to claim 1, further comprising:
a warranty period input section configured to input a warranty period data, wherein the second warranty certificate issue section outputs the warranty certificate data including the warranty period data inputted through the warranty period input section to the printer to issue the warranty certificate.

3. The commodity sales data processing apparatus according to claim 1, further comprising:
a commodity master file configured to store commodity information of the commodity corresponding to the commodity code, wherein the warranty certificate data storage section is associated with the commodity master file.

4. The commodity sales data processing apparatus according to claim 3, wherein the warranty period data inputted through the warranty period input section is able to be inputted from a keyboard.

5. The commodity sales data processing apparatus according to claim 1, wherein the warranty certificate issue instruction section includes a warranty certificate issue key and the operation of the instruction section is carried out such that the warranty certificate issue key is operated and the commodity code is read by a code reader.

6. A method for issuing a warranty certificate by a commodity sales data processing apparatus equipped with a warranty certificate data storage section storing a warranty certificate data, including data required to warrant a commodity, that is associated with a commodity code, the method including:
inputting the commodity code for specifying the commodity;
instructing issue of the warranty certificate of the commodity specified by the commodity code;
determining with reference to the warranty certificate data storage section whether it is set that issue of the warranty certificate is executable or it is set that issue of the warranty certificate is not executable on the commodity specified by the commodity code;
issuing the warranty certificate by reading the warranty certificate data corresponding to the commodity code from the warranty certificate data storage section and by outputting them to a printer if it is determined that it is set that issue of the warranty certificate is executable; and
issuing the warranty certificate by reading the warranty certificate data including data for specifying the commodity from the warranty certificate data storage section based on the commodity code and by outputting them to the printer if it is determined that it is set that issue of the warranty certificate is not executable, and issue of the warranty certificate is instructed.
